(19) United States
(12) Patent Application Publication
(10) Pub. No.: US 2025/0050931 A1
(43) Pub. Date: Feb. 13, 2025

(54) CONVEYANCE CART

(71) Applicant: TOYOTA BOSHOKU KABUSHIKI KAISHA, Aichi-ken (JP)

(72) Inventors: Seiya NISHIMURA, Aichi-ken (JP); Fumitoshi AKAIKE, Aichi-ken (JP); Hiroshi TSUJI, Aichi-ken (JP)

(73) Assignee: TOYOTA BOSHOKU KABUSHIKI KAISHA, Aichi-ken (JP)

(21) Appl. No.: 18/795,455

(22) Filed: Aug. 6, 2024

(30) Foreign Application Priority Data
Aug. 9, 2023 (JP) 2023-130093

(51) Int. Cl. B62B 5/04; B62B 5/00

(52) U.S. Cl. CPC B62B 5/049; B62B 5/0093

(57) ABSTRACT

A conveyance cart capable of traveling with a conveyed object placed on the conveyance cart, the conveyance cart includes a traveling portion configured to travel along a traveling surface, and an engaging portion configured to be engaged with an engaged portion protruding from the traveling surface by movement in a cart forward direction. The engaging portion includes a first engaging portion and a second engaging portion, which are disposed on a bottom portion of a cart body so as to be shifted from each other in a vehicle width direction orthogonal to the cart forward direction and are configured to be individually engaged with the corresponding engaged portion.

### CROSS-REFERENCE TO RELATED APPLICATIONS

This application is based on and claims priority under 35 USC 119 from Japanese Patent Application No. 2023-130093 filed on Aug. 9, 2023, the entire content of which is incorporated herein by reference.

### TECHNICAL FIELD

The present disclosure relates to a conveyance cart. Specifically, the present disclosure relates to a conveyance cart capable of traveling with a conveyed object placed thereon.

### BACKGROUND ART

JP2015-016779A discloses a conveyance cart capable of traveling on a floor surface with a conveyed object placed thereon. The conveyance cart is configured such that a plurality of casters serving as traveling wheels and a hammer lock type stopper are attached to a bottom surface of a loading platform.

In the configuration described in JP2015-016779A, the stopper is gripped on the floor surface by floating the caster from the floor surface. Therefore, it is difficult to fix the conveyance cart to an appropriate position of the floor surface serving as a traveling surface. In view of the above, the present disclosure provides a conveyance cart that can be easily and accurately fixed at a predetermined position on a traveling surface.

The present disclosure provides a conveyance cart having following features.

### SUMMARY

According to the present disclosure, a conveyance cart capable of traveling with a conveyed object placed on the conveyance cart, the conveyance cart includes a traveling portion configured to travel along a traveling surface, and an engaging portion configured to be engaged with an engaged portion protruding from the traveling surface by movement in a cart forward direction. The engaging portion includes a first engaging portion and a second engaging portion, which are disposed on a bottom portion of a cart body so as to be shifted from each other in a vehicle width direction orthogonal to the cart forward direction and are configured to be individually engaged with the corresponding engaged portion.

According to the first aspect, the first engaging portion and the second engaging portion can be engaged with the corresponding engaged portions by the movement in the cart forward direction without abutting on the not corresponding engaged portions. Accordingly, the conveyance cart can be simply and accurately fixed at a predetermined position on the traveling surface.

According to the present disclosure, the traveling portion is disposed to be shifted from the first engaging portion and/or the second engaging portion in the cart forward direction, and is disposed to be shifted in the vehicle width direction from the first engaging portion and/or the second engaging portion disposed to be shifted in a cart backward direction.

According to the second aspect, it is possible to appropriately engage the first engaging portion and/or the second engaging portion, which are disposed to be shifted from the traveling portion in the cart backward direction, with the corresponding engaged portion without abutting the traveling portion on the engaged portion due to the movement in the cart forward direction.

According to the present disclosure, at least one of the first engaging portion or the second engaging portion includes a locking mechanism configured to be releasably locked to the corresponding engaged portion.

According to the third aspect, the first engaging portion and/or the second engaging portion including the locking mechanism can be more accurately fixed to the corresponding engaged portion.

According to the present disclosure, the engaged portion to which the locking mechanism is locked has a frame upper portion and frame side portions forming a three-way frame shape when viewed in a forward direction along the cart forward direction, and the locking mechanism is locked to the frame upper portion of the engaged portion. The conveyance cart further comprising a locking guide configured to guide the locking mechanism to a position directly facing the frame upper portion in the cart forward direction by abutting the engaged portion, to which the locking mechanism is locked, on at least one of the frame side portions in the vehicle width direction.

According to the fourth aspect, the locking mechanism can be locked in a state in which the locking mechanism is more appropriately positioned with respect to the frame upper portion of the engaged portion having the three-way frame shape.

According to the present disclosure, a pair of the first engaging portions and a pair of the second engaging portions are provided in the vehicle width direction. The pair of first engaging portions are disposed to be shifted from the pair of second engaging portions in the cart forward direction, and an arrangement interval between the pair of first engaging portions is smaller than an arrangement interval between the pair of second engaging portions.

According to the fifth aspect, since the pair of first engaging portions and the pair of second engaging portions are provided in the vehicle width direction at positions shifted in the cart forward direction, it is possible to more accurately fix the conveyance cart at the predetermined position on the traveling surface. In addition, since a width between the pair of first engaging portions provided on a front side in the cart forward direction is smaller than a width between the pair of second engaging portions, it is possible to easily and visually perform an operation of engaging the pair of first engaging portions and the pair of second engaging portions with the corresponding engaged portions as compared with a case where the width between the pair of first engaging portions is not smaller than the width between the pair of second engaging portions.

According to the present disclosure, the traveling portion is a traveling wheel including a pair of rear wheels provided in the vehicle width direction and a pair of front wheels provided in the vehicle width direction at positions shifted from the pair of rear wheels in the cart forward direction. The pair of first engaging portions are disposed to be shifted from the pair of front wheels in the cart forward direction and inward in the vehicle width direction, and the pair of second engaging portions are disposed to be shifted from the pair of rear wheels in a cart backward direction and outward in the vehicle width direction.

According to the sixth aspect, by using the traveling wheel as the traveling portion, even if the conveyed object is a heavy load, it is possible to smoothly travel along the traveling surface. In addition, the pair of first engaging portions and the pair of second engaging portions can be appropriately engaged with the corresponding engaged portions without the pair of front wheels and the pair of rear wheels abutting on the engaged portions.

According to the present disclosure, the pair of first engaging portions do not include the locking mechanism, and the pair of second engaging portions include the locking mechanism.

According to the seventh disclosure, a user standing in the cart backward direction of the conveyance cart can easily perform a switching operation of locking and releasing of the locking mechanism.

According to the present disclosure, the conveyance cart further includes an engagement guide that protrudes from the bottom portion of the cart body and configured to guide, by abutment with the engaged portion in the vehicle width direction, the engaged portion such that the engaged portion does not disengage from a position directly below the cart body in the vehicle width direction.

According to the eighth aspect, the engaged portion, with which the first engaging portion and/or the second engaging portion are engaged, can be guided so as not to be disengaged from the position directly below the cart body in the vehicle width direction by the movement in the cart forward direction. Accordingly, the conveyance cart can be more easily fixed at the predetermined position on the traveling surface.

According to the present disclosure, a pair of the first engaging portions and a pair of the second engaging portions are provided in the vehicle width direction. The traveling portion is a traveling wheel including a pair of rear wheels provided in the vehicle width direction and a pair of front wheels provided in the vehicle width direction at positions shifted from the pair of rear wheels in the cart forward direction. The pair of first engaging portions are disposed to be shifted from the pair of front wheels in the cart forward direction and inward in the vehicle width direction, and the pair of second engaging portions are disposed to be shifted from the pair of rear wheels in a cart backward direction and outward in the vehicle width direction. The engagement guide is configured to guide, by abutment with the engaged portion with which the pair of second engaging portions are engaged from an outer side in the vehicle width direction, the engaged portion with which the pair of second engaging portions are engaged such that the engaged portion does not disengage from the position directly below the cart body in the vehicle width direction.

According to the ninth disclosure, the pair of first engaging portions and the pair of second engaging portions can be engaged with the corresponding engaged portions while guiding the engaged portions that are engaged with the pair of second engaging portions passing between the engagement guides in advance with the movement in the cart forward direction. Accordingly, the conveyance cart can be more easily fixed at the predetermined position on the traveling surface.

According to the present disclosure, the traveling portion is a traveling wheel including a pair of rear wheels provided in the vehicle width direction and a pair of front wheels provided in the vehicle width direction at positions shifted from the pair of rear wheels in the cart forward direction.

According to the tenth aspect, by using the traveling wheel as the traveling portion, even if the conveyed object is a heavy load, it is possible to smoothly travel along the traveling surface.

### BRIEF DESCRIPTION OF DRAWINGS

FIG. 1 is a perspective view showing a schematic configuration of a conveyance cart according to a first embodiment;

FIG. 2 is a perspective view showing a state in which the conveyance cart is positioned and fixed to an anchor on a traveling surface;

FIG. 3 is a perspective view of the conveyance cart viewed from a bottom side;

FIG. 4 is a bottom view of the conveyance cart;

FIG. 5 is a perspective view showing an engagement state with the anchor;

FIG. 6 is a perspective view showing a state before a locking mechanism is locked;

FIG. 7 is a perspective view showing a locked state of the locking mechanism;

FIG. 8 is a perspective view showing a state in which the locking mechanism is released;

FIG. 9 is a plan view showing a state in which an engagement guide guides movement of the conveyance cart;

FIG. 10 is a plan view showing a state in which a locking guide guides a position of the locking mechanism;

FIG. 11 is a perspective view showing a schematic configuration of a conveyance cart according to a second embodiment;

FIG. 12 is a plan view showing a state in which the conveyance cart is retracted from a lock position to an intermediate position; and

FIG. 13 is a plan view showing a state in which an anchor on a front side is laterally released from a release hole on the side as the conveyance cart is laterally moved.

### DESCRIPTION OF EMBODIMENTS

Hereinafter, embodiments of the present disclosure will be described with reference to the drawings.

### First Embodiment

### Schematic Configuration of Conveyance Cart 1

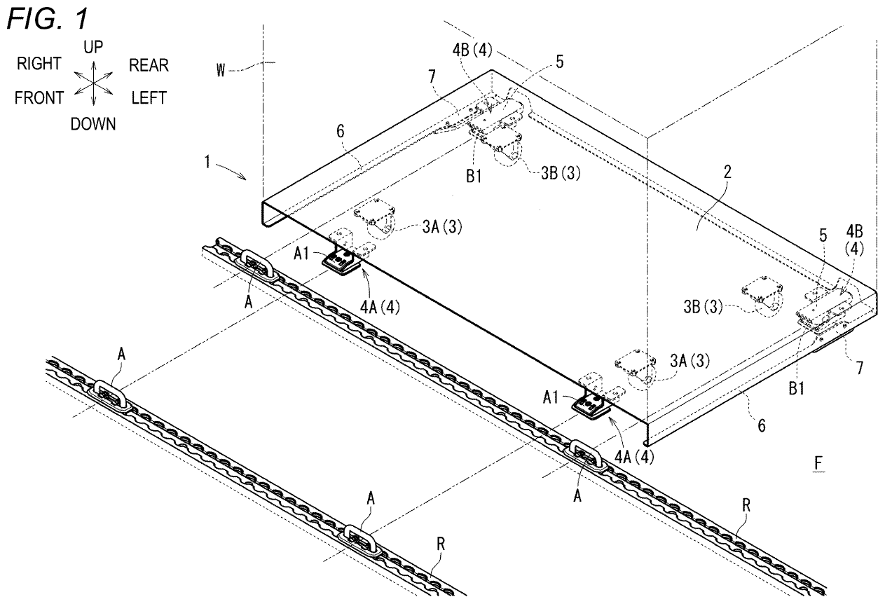

First, a configuration of a conveyance cart 1 according to a first embodiment of the present disclosure will be described with reference to FIGS. 1 to 10. In the following description, when a direction such as front, rear, up, down, left, or right is described, it is assumed that the direction indicates a corresponding direction shown in the drawings.

A direction shown in each drawing is a direction viewed from a user who uses the conveyance cart 1. The “front direction” in each drawing indicates a forward direction (cart forward direction) of the conveyance cart 1. In the following description, when a specific reference diagram is not described or when there is no corresponding reference numeral in the reference diagram, any one of FIGS. 1 to 10 is referred to as appropriate.

As shown in FIG. 1, the conveyance cart 1 according to the present embodiment is implemented as a hand-push-type cart device capable of traveling with a conveyed object W placed thereon. The conveyed object W is, for example, a storage rack serving as a vehicle facility. A traveling surface F on which the conveyance cart 1 travels is, for example, a ground surface or a floor surface of a vehicle. The traveling surface F may be a mounting surface on which the conveyance cart 1 is placed when the conveyance cart 1 is mounted on a conveyance device (not shown) that travels on the floor surface of the vehicle and extends to a tiered stand.

The conveyance cart 1 includes an interlock type stopper structure that can be fixed at a predetermined position on the traveling surface F. Specifically, the conveyance cart 1 is fixed on the traveling surface F by engagement with four anchors A provided at predetermined positions on the traveling surface F. Here, each anchor A corresponds to an “engaged portion” of the present disclosure.

Two anchors A are mounted on each of a pair of front and rear fixed rails R embedded in the traveling surface F and extending in parallel in a vehicle width direction (left-right direction). Each fixed rail R is provided such that an upper surface thereof is exposed flush with the traveling surface F.

Each of the fixed rails R is formed of an air line rail (registered trademark). A mounting structure of the anchor A to the fixed rail R is formed by stud fitting in which mounting positions to the fixed rail R can be adjusted at a predetermined interval in a rail length direction (left-right direction).

Specific configurations of the anchor A and the fixed rail R are described in JP2024-015759A. The mounting positions of the anchors A on the fixed rails R are positions corresponding to arrangement positions of four fitting claws A1 and B1 provided on the conveyance cart 1 described later. Each of the anchors A has a three-way frame shape (inverted U-shape) when viewed in the forward direction along the forward direction of the conveyance cart 1.

The conveyance cart 1 includes a loading platform 2 having a rectangular plate shape in a plan view on which the conveyed object W can be placed, and a traveling portion 3 including four traveling wheels (front wheels 3A and rear wheels 3B) provided on a bottom portion of the loading platform 2. Here, the loading platform 2 corresponds to a “cart body” of the present disclosure. The traveling portion 3 includes a pair of the front wheels 3A on a front side and a pair of the rear wheels 3B on a rear side. Each of the front wheels 3A and the rear wheels 3B includes a universal caster. The front wheels 3A or the rear wheels 3B may include fixed casters.

In addition, the conveyance cart 1 further includes an engaging portion 4 including four engaging portions (first engaging portions 4A and second engaging portions 4B) provided on the bottom portion of the loading platform 2. The engaging portion 4 includes a pair of the first engaging portions 4A on the front side and a pair of the second engaging portions 4B on the rear side.

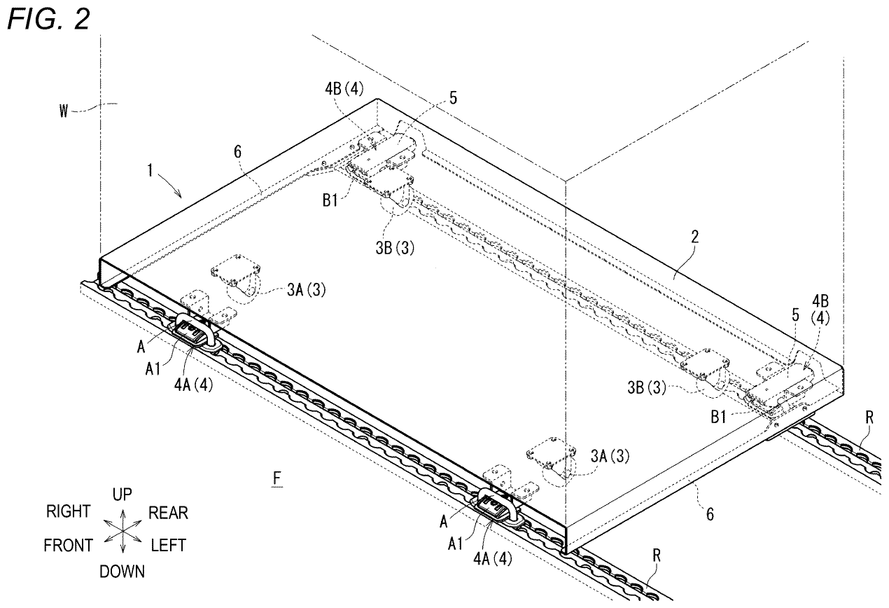

The first engaging portions 4A and the second engaging portions 4B respectively have the fitting claws A1 and B1 that are fitted to frames of the corresponding anchors A provided on the traveling surface F by moving the conveyance cart 1 in the forward direction (see FIG. 2). By the fitting of the fitting claws A1 and B1, the movement of the conveyance cart 1 in the forward direction and the movement in the vehicle width direction (left-right direction) with respect to the traveling surface F are restricted.

Specifically, in the pair of first engaging portions 4A on the front side, the fitting claws A1 are fitted to a pair of the corresponding anchors A provided on the fixed rail R on the front side. In addition, in the pair of second engaging portions 4B on the rear side, the fitting claws B1 are fitted to a pair of the corresponding anchors A provided on the fixed rail R on the rear side. The pair of second engaging portions 4B on the rear side further include locking mechanisms 5 that are releasably locked to the corresponding anchors A.

The locking mechanisms 5 are locked to be hooked on frame upper portions A2 of the corresponding anchors A as the fitting claws B1 of the second engaging portions 4B are fitted to the corresponding anchors A by the movement of the conveyance cart 1 in the forward direction. Accordingly, the movement of the conveyance cart 1 in a backward direction (cart backward direction) with respect to the traveling surface F is restricted.

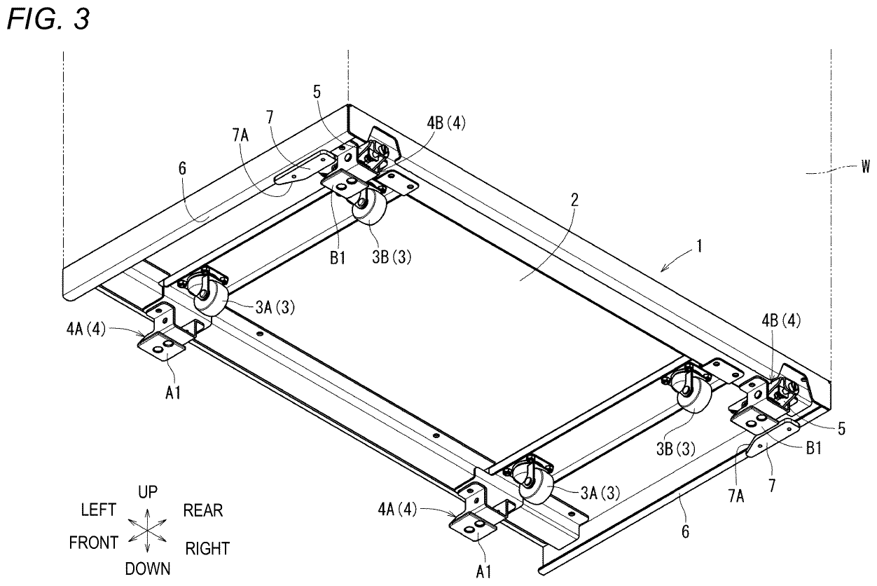

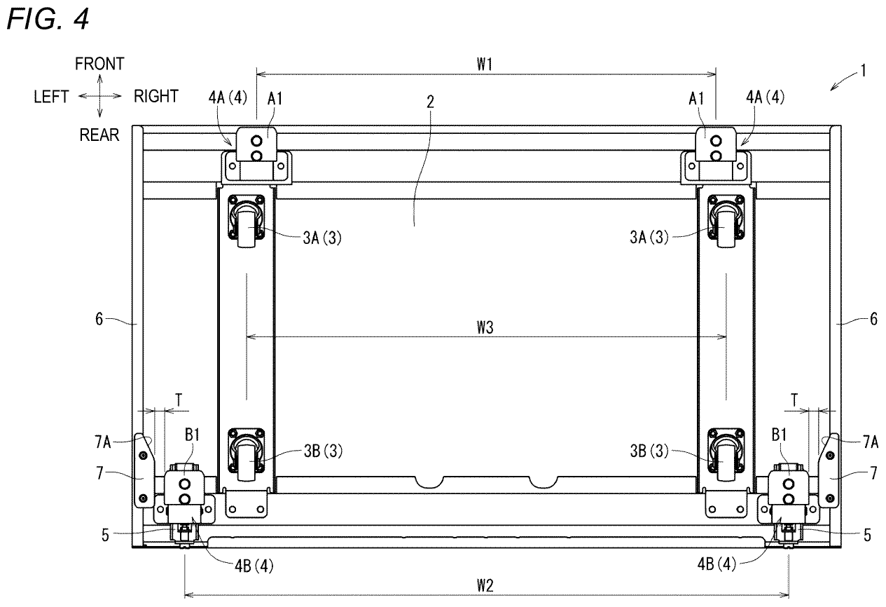

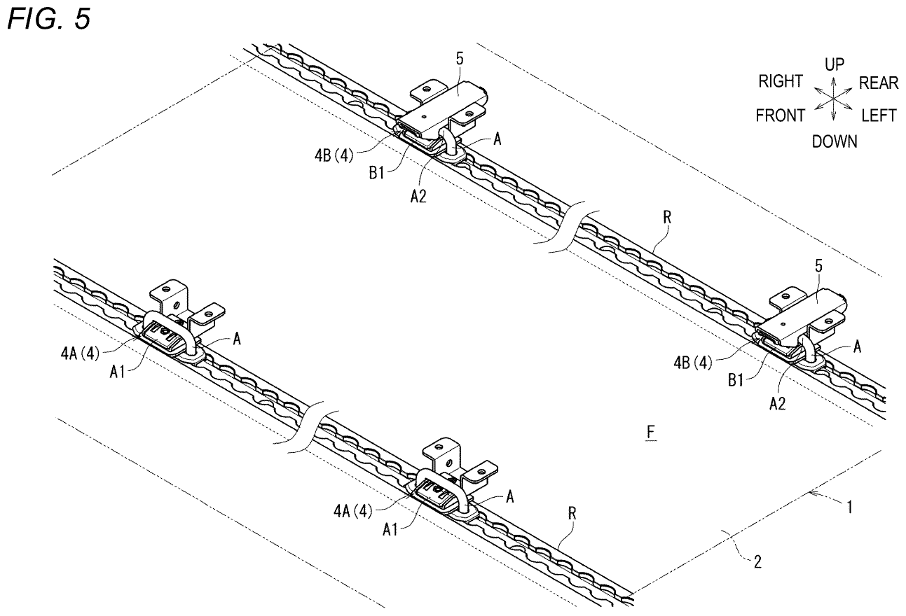

As shown in FIGS. 3 and 4, the fitting claws A1 of the pair of first engaging portions 4A on the front side and the fitting claws B1 of the pair of second engaging portions 4B on the rear side are disposed at positions shifted from each other in the vehicle width direction. Accordingly, as shown in FIG. 5, the fitting claws A1 of the first engaging portions 4A and the fitting claws B1 of the second engaging portions 4B can be accurately fitted to the corresponding anchors A on the traveling surface F by a simple operation of only moving the conveyance cart 1 straight in the forward direction. That is, the fitting claws A1 of the first engaging portions 4A and the fitting claws B1 of the second engaging portions 4B can be accurately fitted only to the corresponding anchors A without abutting on the not corresponding anchors A.

As shown in FIG. 4, the pair of first engaging portions 4A on the front side and the pair of second engaging portions 4B on the rear side are disposed at symmetrical positions on the bottom portion of the loading platform 2. The pair of first engaging portions 4A on the front side are disposed at substantially front end positions on the bottom portion of the loading platform 2. The pair of second engaging portions 4B on the rear side are disposed at substantially rear end positions on the bottom portion of the loading platform 2.

An arrangement interval W1 (distance between centers) between the fitting claws A1 of the pair of first engaging portions 4A on the front side is smaller than an arrangement interval W2 (distance between centers) between the fitting claws B1 of the pair of second engaging portions 4B on the rear side. Specifically, the fitting claws B1 of the pair of second engaging portions 4B on the rear side are disposed at substantially outer end positions in the vehicle width direction on the bottom portion of the loading platform 2.

Specifically, the fitting claws B1 of the pair of second engaging portions 4B on the rear side are disposed side by side at an interval T from inner positions in the vehicle width direction of locking guides 7 provided at outer end positions in the vehicle width direction on the bottom portion of the loading platform 2. The interval T between the fitting claw B1 and the locking guide 7 in the vehicle width direction is set to be slightly larger than a wall thickness of an outer frame side portion of the corresponding anchor A (see FIG. 1) to which the fitting claw B1 is fitted, and is set to be substantially the same size as the wall thickness.

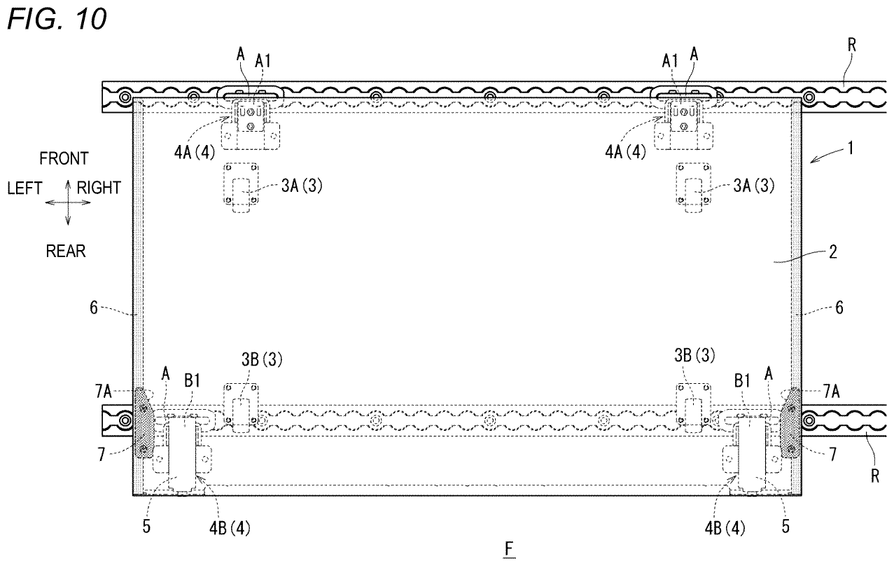

Accordingly, as shown in FIG. 10, the outer frame side portion of the corresponding anchor A is guided by the locking guide 7 so as to be guided between the locking guide 7 and the fitting claw B1 of the second engaging portion 4B as the conveyance cart 1 moves in the forward direction. With this guide, the fitting claw B1 of the second engaging portion 4B is appropriately fitted to the frame of the corresponding anchor A. Details will be described later.

As shown in FIG. 4, the fitting claws A1 of the pair of first engaging portions 4A on the front side are disposed at positions inward of the fitting claws B1 of the pair of second engaging portions 4B on the rear side in the vehicle width direction. Specifically, the fitting claws A1 of the pair of first engaging portions 4A on the front side are disposed so as not to overlap the fitting claws B1 of the pair of second engaging portions 4B on the rear side in the vehicle width direction.

The pair of front wheels 3A on the front side and the pair of rear wheels 3B on the rear side forming the traveling portion 3 are respectively disposed at symmetrical positions on the bottom portion of the loading platform 2. The pair of front wheels 3A on the front side and the pair of rear wheels 3B on the rear side have the same arrangement interval W3 (distance between centers) between left and right wheels.

Accordingly, the pair of front wheels 3A on the front side and the pair of rear wheels 3B on the rear side are disposed such that the right wheels overlap each other in the vehicle width direction and the left wheels overlap each other in the vehicle width direction. The arrangement interval W3 between the pair of front wheels 3A on the front side and between the pair of rear wheels 3B on the rear side in the vehicle width direction is larger than the arrangement interval W1 between the fitting claws A1 of the pair of first engaging portions 4A on the front side and smaller than the arrangement interval W2 between the fitting claws B1 of the pair of second engaging portions 4B on the rear side.

Specifically, the pair of front wheels 3A on the front side and the pair of rear wheels 3B on the rear side are disposed so as to partially overlap the fitting claws A1 of the pair of first engaging portions 4A on the front side in the vehicle width direction. In addition, the pair of front wheels 3A on the front side and the pair of rear wheels 3B on the rear side are disposed so as not to overlap the fitting claws B1 of the pair of second engaging portions 4B on the rear side in the vehicle width direction.

The pair of front wheels 3A on the front side are disposed at positions behind the fitting claws A1 of the pair of first engaging portions 4A on the front side. Further, the pair of rear wheels 3B on the rear side are disposed at positions in front of the fitting claws B1 of the pair of second engaging portions 4B on the rear side.

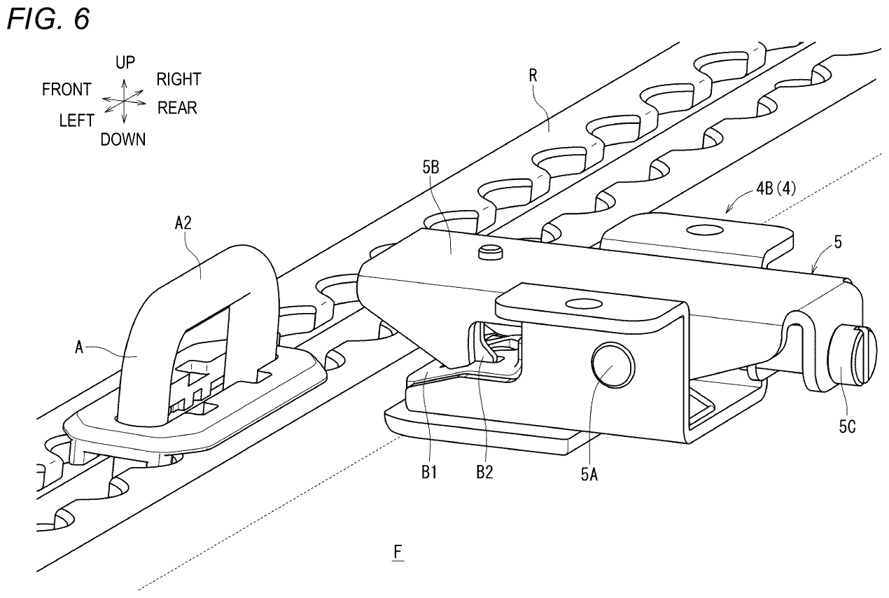

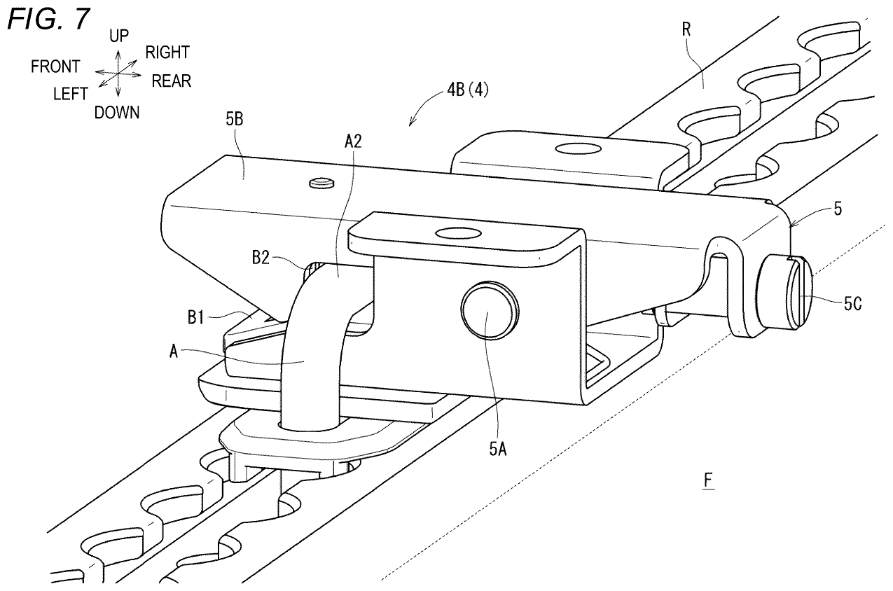

As shown in FIG. 6, each locking mechanism 5 includes a locking arm 5B rotatably connected to the fitting claw B1 of the corresponding second engaging portion 4B through a support shaft 5A extending in the vehicle width direction, and a position adjustment bolt 5C attached to the locking arm 5B. The locking arm 5B is hooked on the frame upper portion A2 of the anchor A from above by a biasing force of a spring (not shown), as the corresponding fitting claw B1 is fitted to the frame of the anchor A, and after a claw portion B2 at a tip end of the locking arm 5B abuts on the frame upper portion A2 of the anchor A and is pushed and rotated upward (see FIG. 7).

Accordingly, as shown in FIG. 7, the locking arm 5B is in a state of being positioned and fixed to the anchor A by sandwiching the anchor A in a front-rear direction between the claw portion B2 at the tip end of the locking arm 5B and the fitting claw B1. The locking arm 5B has a double arm structure. The position adjustment bolt 5C is screwed into the locking arm 5B having the double arm structure from the rear side.

The position adjustment bolt 5C shifts a positional relationship in the double arm structure of the locking arm 5B in the front-rear direction by an operation of rotating a head portion at a rear end of the position adjustment bolt 5C. Accordingly, a distance between the claw portion B2 at the tip end of the locking arm 5B and the frame upper portion A2 of the anchor A is adjusted. By this adjustment, a gap, in which the frame upper portion A2 of the anchor A is sandwiched in the front-rear direction between the claw portion B2 of the locking arm 5B and the fitting claw B1, is adjusted. As a result, the locking mechanism 5 can be locked to the corresponding anchor A in a state in which backlash is restrained.

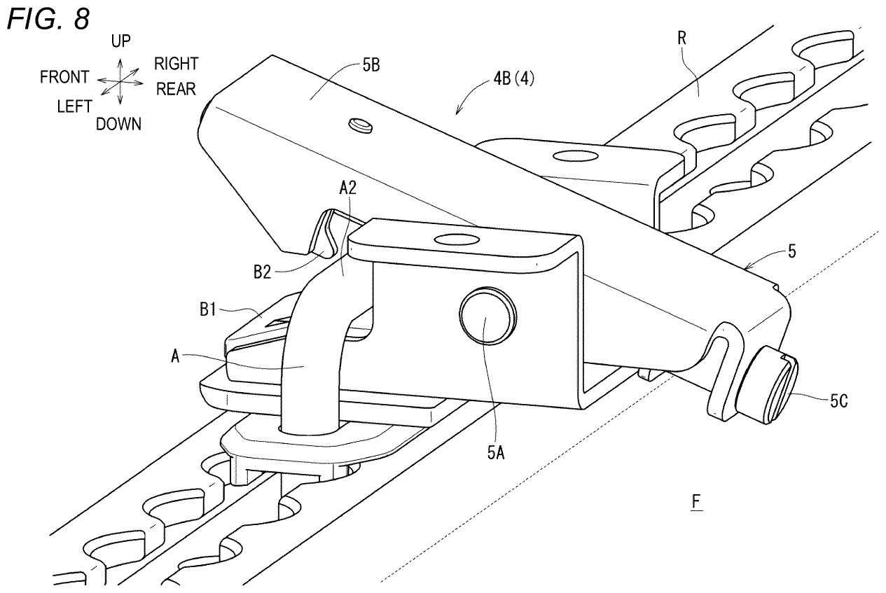

As shown in FIG. 8, the respective locking mechanism 5 is disengaged from the locked state with respect to the anchor A by the user gripping the locking arm 5B and pushing and rotating the locking arm 5B in a direction opposite to a biasing direction of the spring (not shown). A fitting structure of the fitting claw B1 (A1) to the anchor A and a specific configuration of the locking mechanism 5 are described in JP2023-055419A.

As shown in FIGS. 3 and 4, an engagement guide 6 having an elongated plate shape and protruding downward from left and right side edges of the bottom portion of the loading platform 2 is formed on the bottom portion of the loading platform 2. The engagement guide 6 is formed over the entire region in the front-rear direction along the side edge of the bottom portion of the loading platform 2. The engagement guide 6 has a shape that is folded back so as to protrude further inward in the vehicle width direction in an eaves shape from a tip protruding downward.

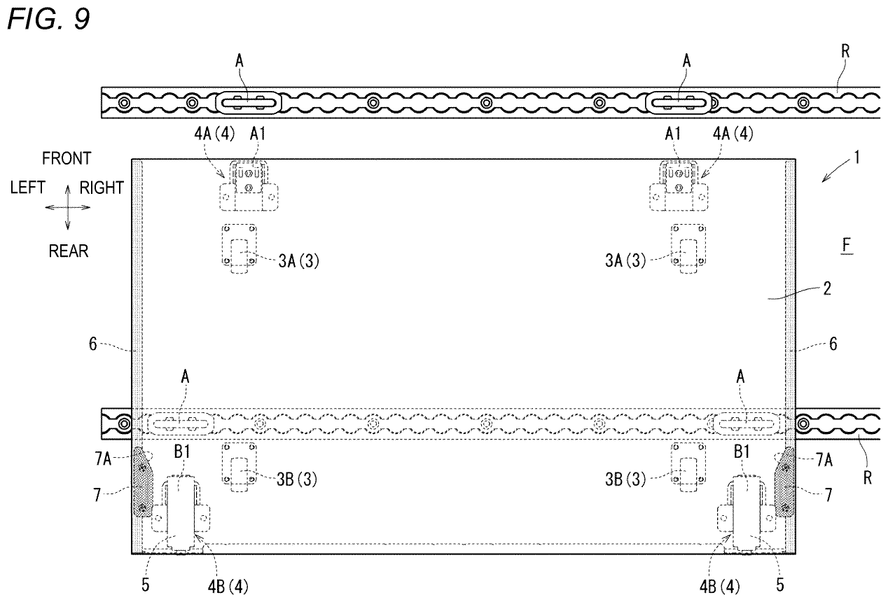

The engagement guide 6 has a shape in which an eaves folded portion thereof protrudes to a low position such that the eaves folded portion overlaps with the anchor A (see FIG. 1) provided on the traveling surface F in a height direction. Accordingly, as shown in FIG. 9, the engagement guides 6 are configured such that the two anchors A on the rear side (front side) enter a position directly below the loading platform 2 as the conveyance cart 1 moves in the forward direction, and the eaves folded portions of the engagement guides 6 face each other from the outer side in the vehicle width direction at positions on both left and right outer sides of the anchors A.

Accordingly, even if the engagement guide 6 is bent in the vehicle width direction when the conveyance cart 1 moves in the forward direction, the engagement guide 6 can guide the anchor A so as not to disengage from a position directly below the loading platform 2 in the vehicle width direction by abutting on the anchor A in the vehicle width direction. Accordingly, as the conveyance cart 1 moves in the forward direction, the fitting claws A1 of the first engaging portions 4A and the fitting claws B1 of the second engaging portions 4B can be fitted to the corresponding anchors A while guiding the two anchors A on the rear side that are inserted between the engagement guides 6 in advance.

As shown in FIGS. 3 and 4, the locking guide 7 extending in an elongated plate shape in the front-rear direction is coupled to the engagement guide 6 in an overlapping manner in a rear region of a bottom surface folded back in the eaves shape of the engagement guide 6. The locking guide 7 has a shape protruding inward in the vehicle width direction from the engagement guide 6. An inner surface of the locking guide 7 in the vehicle width direction is formed in a surface shape extending parallel to the forward direction of the conveyance cart 1. An inclined surface 7A is formed in a front region of the inner surface of the locking guide 7 such that the protrusion from the engagement guide 6 gradually decreases toward the front.

The inclined surface 7A of the locking guide 7 is formed at a position in front of the fitting claw B1 of the second engaging portion 4B. In addition, the inner surface of the locking guide 7 and a position on the outer side of the fitting claw B1 of the second engaging portion 4B in the vehicle width direction are disposed side by side at the interval T.

As shown in FIG. 10, the locking guide 7 is disposed outside the outer frame side portion of the anchor A by the two anchors A on the rear side (front side) approaching the fitting claws B1 of the second engaging portions 4B from the front side as the conveyance cart 1 moves in the forward direction. Accordingly, the anchor A is inserted between the inner surfaces of the locking guide 7 in a sandwich shape.

At this time, even if the anchor A is shifted in the vehicle width direction from the position where the anchor A directly face the fitting claw B1 of the second engaging portion 4B and approaches the fitting claw B1 as the conveyance cart 1 moves in the forward direction, the anchor A can easily pass between the inner surfaces of the locking guide 7 by the guide along the inclined surface 7A of the locking guide 7. Accordingly, the anchor A is guided to a position directly facing the fitting claw B1 of the second engaging portion 4B, and is appropriately fitted to the fitting claw B1.

At the same time, the two anchors A on the front side (back side) are also guided by the guide to positions directly facing the fitting claws A1 of the first engaging portions 4A, and are appropriately fitted to the fitting claws A1. Accordingly, the locking mechanism 5 can be appropriately locked according to positions directly facing the frame upper portions A2 of the two corresponding anchors A on the rear side (front side).

In summary, the conveyance cart 1 according to the present embodiment has the following configuration. In the following description, reference numerals assigned in parentheses correspond to the configurations described in the embodiment described above.

That is, a conveyance cart (1) is a vehicle capable of traveling with a conveyed object (W) placed thereon. The conveyance cart (1) includes: a traveling portion (3) traveling along a traveling surface (F); and an engaging portion (4) engaged with an engaged portion (A) protruding from the traveling surface (F) by movement in a cart forward direction. The engaging portion (4) includes a first engaging portion (4A) and a second engaging portion (4B), which are disposed on a bottom portion of a cart body (2) so as to be shifted from each other in a vehicle width direction orthogonal to the cart forward direction and are individually engaged with the corresponding engaged portion (A).

According to the above configuration, the first engaging portion (4A) and the second engaging portion (4B) can be engaged with the corresponding engaged portions (A) by the movement in the cart forward direction without abutting on the not corresponding engaged portions (A). Accordingly, the conveyance cart (1) can be simply and accurately fixed at a predetermined position on the traveling surface (F).

In addition, the traveling portion (3) is disposed to be shifted from the first engaging portion (4A) and/or the second engaging portion (4B) in the cart forward direction, and is disposed to be shifted in the vehicle width direction from the first engaging portion (4A) and/or the second engaging portion (4B) disposed to be shifted in a cart backward direction. According to the above configuration, it is possible to appropriately engage the first engaging portion (4A) and/or the second engaging portion (4B), which are disposed to be shifted from the traveling portion (3) in the cart backward direction, with the corresponding engaged portion (A) without abutting the traveling portion (3) on the engaged portion (A) due to the movement in the cart forward direction.

In addition, the first engaging portion (4A) and/or the second engaging portion (4B) includes a locking mechanism (5) that is releasably locked to the corresponding engaged portion (A). According to the above configuration, the first engaging portion (4A) and/or the second engaging portion (4B) including the locking mechanism (5) can be more accurately fixed to the corresponding engaged portion (A).

In addition, the engaged portion (A) to which the locking mechanism (5) is locked forms a three-way frame shape when viewed in a forward direction along the cart forward direction, and the locking mechanism (5) is locked to a frame upper portion (A2) of the engaged portion (A). The conveyance cart (1) includes a locking guide (7) that guides the locking mechanism (5) to a position directly facing the frame upper portion (A2) in the cart forward direction by abutting the engaged portion (A), to which the locking mechanism (5) is locked, on a frame side portion in the vehicle width direction. According to the above configuration, the locking mechanism (5) can be locked in a state in which the locking mechanism (5) is more appropriately positioned with respect to the frame upper portion (A2) of the engaged portion (A) having the three-way frame shape.

In addition, a pair of the first engaging portions (4A) and a pair of the second engaging portions (4B) are provided in the vehicle width direction. The pair of first engaging portions (4A) are disposed to be shifted from the pair of second engaging portions (4B) in the cart forward direction, and an arrangement interval (W1) between the pair of first engaging portions (4A) is smaller than an arrangement interval (W2) between the pair of second engaging portions (4B).

According to the above configuration, since the pair of first engaging portions (4A) and the pair of second engaging portions (4B) are provided in the vehicle width direction at positions shifted in the cart forward direction, it is possible to more accurately fix the conveyance cart (1) at the predetermined position on the traveling surface (F). In addition, since a width between the pair of first engaging portions (4A) provided on a front side in the cart forward direction is smaller than a width between the pair of second engaging portions (4B), it is possible to easily and visually perform an operation of engaging the pair of first engaging portions (4A) and the pair of second engaging portions (4B) with the corresponding engaged portions (A) as compared with a case where the width between the pair of first engaging portions (4A) is not smaller than the width between the pair of second engaging portions (4B).

In addition, the traveling portion (3) is a traveling wheel including a pair of rear wheels (3B) provided in the vehicle width direction and a pair of front wheels (3A) provided in the vehicle width direction at positions shifted from the pair of rear wheels (3B) in the cart forward direction. The pair of first engaging portions (4A) are disposed to be shifted from the pair of front wheels (3A) in the cart forward direction and inward in the vehicle width direction. The pair of second engaging portions (4B) are disposed to be shifted from the pair of rear wheels (3B) in the cart backward direction and outward in the vehicle width direction.

According to the above configuration, by using the traveling wheel as the traveling portion (3), even if the conveyed object (W) is a heavy load, it is possible to smoothly travel along the traveling surface (F). In addition, the pair of first engaging portions (4A) and the pair of second engaging portions (4B) can be appropriately engaged with the corresponding engaged portions (A) without the pair of front wheels (3A) and the pair of rear wheels (3B) abutting on the engaged portions (A).

In addition, in the configuration as the above arrangement, the pair of first engaging portions (4A) do not include the locking mechanism, and the pair of second engaging portions (4B) include the locking mechanism (5). According to the above configuration, a user standing in the cart backward direction of the conveyance cart (1) can easily perform a switching operation of locking and releasing of the locking mechanism (5).

In addition, the conveyance cart (1) further includes an engagement guide (6) that protrudes from the bottom portion of the cart body (2) and guides, by abutment with the engaged portion (A) in the vehicle width direction, the engaged portion (A) such that the engaged portion (A) does not disengage from a position directly below the cart body (2) in the vehicle width direction. According to the above configuration, the engaged portion (A), with which the first engaging portion (4A) and/or the second engaging portion (4B) are engaged, can be guided so as not to be disengaged from the position directly below the cart body (2) in the vehicle width direction by the movement in the cart forward direction. Accordingly, the conveyance cart (1) can be more easily fixed at the predetermined position on the traveling surface (F).

In addition, a pair of the first engaging portions (4A) and a pair of the second engaging portions (4B) are provided in the vehicle width direction. The pair of first engaging portions (4A) are disposed to be shifted from the pair of front wheels (3A) in the cart forward direction and inward in the vehicle width direction. The pair of second engaging portions (4B) are disposed to be shifted from the pair of rear wheels (3B) in the cart backward direction and outward in the vehicle width direction. The engagement guide (6) guides, by abutment with the engaged portion (A) with which the pair of second engaging portions (4B) are engaged from an outer side in the vehicle width direction, the engaged portion (A) with which the pair of second engaging portions (4B) are engaged such that the engaged portion (A) does not disengage from the position directly below the cart body (2) in the vehicle width direction.

According to the above configuration, the pair of first engaging portions (4A) and the pair of second engaging portions (4B) can be engaged with the corresponding engaged portions (A) while guiding the engaged portions (A) that are engaged with the pair of second engaging portions (4B) passing between the engagement guides (6) in advance with the movement in the cart forward direction. Accordingly, the conveyance cart (1) can be more easily fixed at the predetermined position on the traveling surface (F).

### Second Embodiment

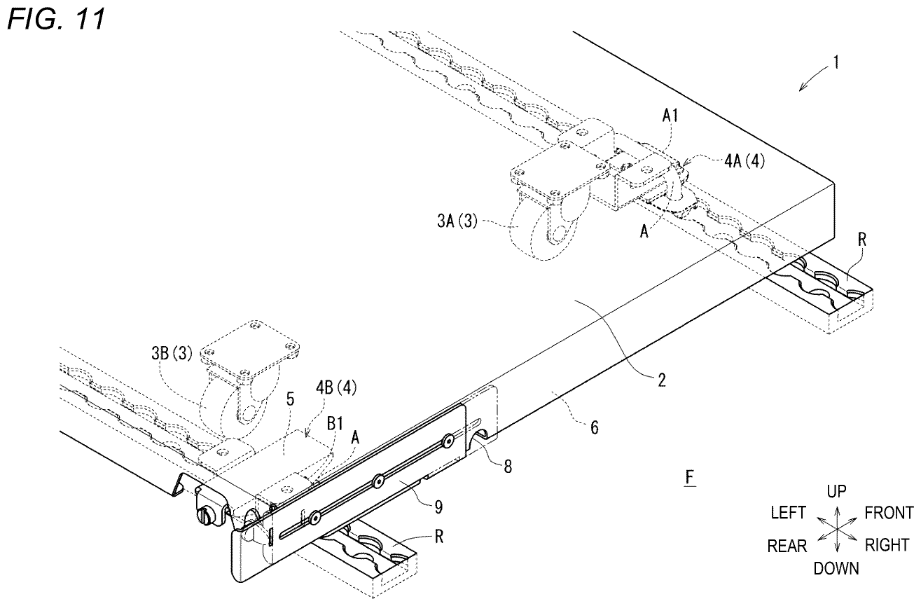

Next, a configuration of the conveyance cart 1 according to a second embodiment of the present disclosure will be described with reference to FIGS. 11 to 13. As shown in FIG. 11, in the present embodiment, a release hole 8 of a downward opening is formed in an intermediate portion of the engagement guide 6 in a front-rear direction in a manner of scooping through the engagement guide 6 in a vehicle width direction. In addition, a manual slide lid 9 is attached to an outer side portion of the engagement guide 6 so as to be switched to cover or open the release hole 8 from the outside by sliding in the front-rear direction.

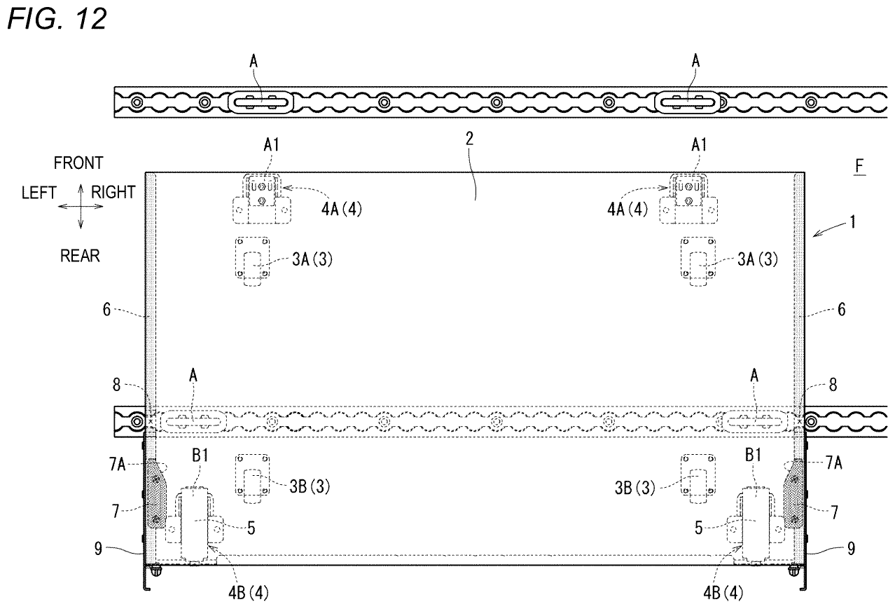

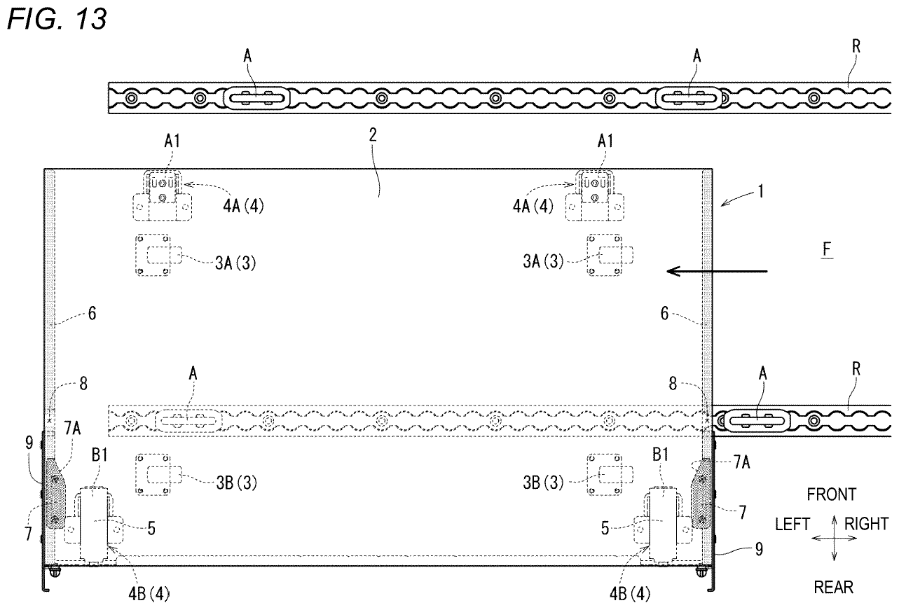

As shown in FIG. 12, the release hole 8 is disposed to be aligned with two anchors A on the rear side (front side) in a straight line shape in the vehicle width direction by retracting the conveyance cart 1 from a lock position with respect to the anchors A. The release hole 8 is formed in a shape that allows the anchor A to pass therethrough laterally by opening the slide lid 9 from a state in which the release hole 8 is disposed to be laterally aligned with the two anchors A on the rear side and moving the conveyance cart 1 laterally (either leftward or rightward) (see FIG. 13).

As shown in FIG. 12, the conveyance cart 1 is in a state in which, the release holes 8 are retracted to positions aligned with the two anchors A on the rear side in a straight line shape in the vehicle width direction, so that the release holes 8 do not overlap the two anchors A on the front side (back side) in the front-rear direction. Accordingly, by laterally moving the conveyance cart 1 from this state, the conveyance cart 1 can be moved to a position where the conveyance cart 1 is disengaged from the anchor A in the vehicle width direction. Therefore, when it is desired to laterally move the conveyance cart 1, it is possible to easily laterally move the conveyance cart 1 with a small amount of movement without laterally moving the conveyance cart 1 after retracting the conveyance cart 1 to the rear side of the two anchors A on the rear side (front side).

The release hole 8 can be covered with good appearance so as not to be exposed to the outside by closing the slide lid 9 except when the conveyance cart 1 is laterally moved. The configuration other than the above is the same as that of the conveyance cart 1 shown in the first embodiment. Accordingly, the same reference numerals are given to such a configuration, and the description thereof will be omitted.

### OTHER EMBODIMENTS

The embodiments according to the present disclosure have been described with reference to the two embodiments, and the present disclosure can be implemented in various forms other than the above embodiments.

1. A conveyed object conveyed by a conveyance cart according to the present disclosure can be various vehicle facilities mounted according to specifications of a vehicle in addition to a storage rack. In addition to the vehicle facilities, the conveyed object may be an object other than vehicle facilities such as furnishings, furniture, or appliances.

2. A traveling portion may be formed of a slider or a rail that slides on a traveling surface, in addition to traveling wheels. In addition, when the traveling portion is formed of the traveling wheels, the number of front wheels and the number of rear wheels are not particularly limited. That is, three or more front wheels and three or more rear wheels may be provided, or different numbers of front wheels and rear wheels may be provided. In addition, the traveling wheels may be configured such that a middle wheel is provided between the front wheel and the rear wheel. The number of middle wheels is the same as the number of front wheels and the number of rear wheels, is not limited to a specific number.

3. An engaging structure of the engaging portion and the engaged portion is not limited to a specific structure as long as the engaging portion and the engaged portion engage with each other by movement of the engaging portion with respect to the engaged portion in a cart forward direction. For example, the engaging portion provided on the conveyance cart may be a frame-shaped member such as the anchor shown in the above embodiments, and the engaged portion provided on the traveling surface may be a member fitted to a frame of the engaging portion such as the fitting claw shown in the above embodiments.

In addition, at least one of the engaging portion and the engaged portion may be elastically fitted to each other by having an elastic structure such as rubber or snap fit. In addition, the engaging portion and the engaged portion may fix the conveyance cart at a predetermined position on the traveling surface only by a sliding frictional resistance force generated by mutual engagement. A locking mechanism may be provided in the engaged portion in addition to the engaging portion. The locking mechanism may be provided in a first engaging portion in addition to a second engaging portion.

The number of first engaging portions and the number of second engaging portions are not particularly limited. That is, one first engaging portion and one second engaging portion may be provided, or three or more first engaging portions and three or more second engaging portions may be provided. In addition, the number of first engaging portions and the number of second engaging portions may be different from each other. In addition, when at least one of the first engaging portion and the second engaging portion is provided in plural, the first engaging portion and the second engaging portion may be provided to be alternately disposed in the vehicle width direction.

Either the first engaging portion or the second engaging portion may be disposed on an inner side or an outer side in the vehicle width direction. Either the first engaging portion or the second engaging portion may be disposed on a front side or a rear side in the cart forward direction. The first engaging portion and the second engaging portion may be disposed to be shifted in a laterally aligned shape in the vehicle width direction such that the first engaging portion and the second engaging portion overlap each other in the cart forward direction.

When a pair of the first engaging portions and a pair of the second engaging portions are provided in the vehicle width direction, and the pair of first engaging portions are disposed to be shifted from the pair of second engaging portions in the cart forward direction, an arrangement interval between the pair of first engaging portions may be larger than an arrangement interval between the pair of second engaging portions.

Both the first engaging portion and the second engaging portion may be disposed on the front side or the rear side of the traveling portion. In addition, both the first engaging portion and the second engaging portion may be disposed on the rear side of the front wheels and on the front side of the rear wheels that form the traveling portion. In addition, both the first engaging portion and the second engaging portion may be disposed on the right side of the left wheels and on the left side of the right wheels that form the traveling portion.

4. The conveyance cart may have a configuration in which the traveling portion and the engaging portion are provided on a support portion (a cart body) supporting a loading platform, in addition to a configuration in which the traveling portion and the engaging portion are provided on a bottom portion of a loading platform serving as the cart body. A locking guide and an engagement guide may be provided in the cart body only in one of the vehicle width directions. The locking guide and the engagement guide may abut on the engaged portion from an outer side in the vehicle width direction, or may abut on the engaged portion from an inner side in the vehicle width direction. In addition, both the outer side and the inner side in the vehicle width direction may be abutted.

What is claimed is:

1. A conveyance cart capable of traveling with a conveyed object placed on the conveyance cart, the conveyance cart comprising:
a traveling portion configured to travel along a traveling surface; and
an engaging portion configured to be engaged with an engaged portion protruding from the traveling surface by movement in a cart forward direction, wherein
the engaging portion includes a first engaging portion and a second engaging portion, which are disposed on a bottom portion of a cart body so as to be shifted from each other in a vehicle width direction orthogonal to the cart forward direction and are configured to be individually engaged with the corresponding engaged portion.

2. The conveyance cart according to claim 1, wherein
the traveling portion is disposed to be shifted from the second engaging portion in the cart forward direction, and is disposed to be shifted in the vehicle width direction from the second engaging portion disposed to be shifted in a cart backward direction.

3. The conveyance cart according to claim 1, wherein
the traveling portion is disposed to be shifted from the first engaging portion in the cart forward direction, and is disposed to be shifted in the vehicle width direction from the first engaging portion disposed to be shifted in a cart backward direction.

4. The conveyance cart according to claim 1, wherein
at least one of the first engaging portion or the second engaging portion includes a locking mechanism configured to be releasably locked to the corresponding engaged portion.

5. The conveyance cart according to claim 4, wherein
the engaged portion to which the locking mechanism is locked has a frame upper portion and frame side portions forming a three-way frame shape when viewed in a forward direction along the cart forward direction, and the locking mechanism is locked to the frame upper portion of the engaged portion, and
the conveyance cart further comprising a locking guide configured to guide the locking mechanism to a position directly facing the frame upper portion in the cart forward direction by abutting the engaged portion, to which the locking mechanism is locked, on at least one of the frame side portions in the vehicle width direction.

6. The conveyance cart according to claim 4, wherein
a pair of the first engaging portions and a pair of the second engaging portions are provided in the vehicle width direction, and
the pair of first engaging portions are disposed to be shifted from the pair of second engaging portions in the cart forward direction, and an arrangement interval between the pair of first engaging portions is smaller than an arrangement interval between the pair of second engaging portions.

7. The conveyance cart according to claim 6, wherein
the traveling portion is a traveling wheel including a pair of rear wheels provided in the vehicle width direction and a pair of front wheels provided in the vehicle width direction at positions shifted from the pair of rear wheels in the cart forward direction, and
the pair of first engaging portions are disposed to be shifted from the pair of front wheels in the cart forward direction and inward in the vehicle width direction, and the pair of second engaging portions are disposed to be shifted from the pair of rear wheels in a cart backward direction and outward in the vehicle width direction.

8. The conveyance cart according to claim 7, wherein
the pair of first engaging portions do not include the locking mechanism, and the pair of second engaging portions include the locking mechanism.

9. The conveyance cart according to claim 1, further comprising:
an engagement guide that protrudes from the bottom portion of the cart body and configured to guide, by abutment with the engaged portion in the vehicle width direction, the engaged portion such that the engaged portion does not disengage from a position directly below the cart body in the vehicle width direction.

10. The conveyance cart according to claim 9, wherein
a pair of the first engaging portions and a pair of the second engaging portions are provided in the vehicle width direction,
the traveling portion is a traveling wheel including a pair of rear wheels provided in the vehicle width direction and a pair of front wheels provided in the vehicle width direction at positions shifted from the pair of rear wheels in the cart forward direction,
the pair of first engaging portions are disposed to be shifted from the pair of front wheels in the cart forward direction and inward in the vehicle width direction, and the pair of second engaging portions are disposed to be shifted from the pair of rear wheels in a cart backward direction and outward in the vehicle width direction, and
the engagement guide is configured to guide, by abutment with the engaged portion with which the pair of second engaging portions are engaged from an outer side in the vehicle width direction, the engaged portion with which the pair of second engaging portions are engaged such that the engaged portion does not disengage from the position directly below the cart body in the vehicle width direction.

11. The conveyance cart according to claim 1, wherein
the traveling portion is a traveling wheel including a pair of rear wheels provided in the vehicle width direction and a pair of front wheels provided in the vehicle width direction at positions shifted from the pair of rear wheels in the cart forward direction.

12. A conveyance cart that engages with a plurality of engaged portions provided on two rails provided on a traveling surface, the conveyance cart comprising:
a cart body;
a traveling portion provided on a bottom portion of the cart body and configured to move the conveyance cart along the traveling surface; and
a plurality of engaging portions provided on the bottom portion of the cart body and configured to engage with the plurality of engaged portions by movement in a first direction, wherein
the plurality of engaging portions includes a plurality of first engaging portions that engage with a plurality of first engaged portions provided on a first rail disposed on a front side in the first direction among the two rails, and a plurality of second engaging portions that engage with a plurality of second engaged portions provided on a second rail disposed on a rear side in the first direction among the two rails, and
the plurality of first engaging portions is disposed to be shifted from the plurality of second engaging portions in a second direction intersecting the first direction and parallel to the bottom portion.

13. The conveyance cart according to claim 12, wherein
in the second direction, an interval between the plurality of first engaging portions is smaller than an interval of the traveling portions, and an interval between the plurality of second engaging portions is larger than the interval of the traveling portions.

14. The conveyance cart according to claim 12, wherein
in the second direction, an interval between the plurality of second engaging portions is smaller than an interval of the traveling portions, and an interval between the plurality of first engaging portions is larger than the interval of the traveling portions.
